(19) United States
(12) Patent Application Publication
(10) Pub. No.: US 2008/0223162 A1
(43) Pub. Date: Sep. 18, 2008

(54) Conical Gear with Connecting Toothing

(75) Inventor: Frank Zerling, Reithofen (DE)

Correspondence Address: KATTEN MUCHIN ROSENMAN LLP, 575 MADISON AVENUE, NEW YORK, NY, 10022-2585, US

(73) Assignee: SONA BLW PRAZISIONSSCHMIEDE GMBH, Munchen (DE)

(21) Appl. No.: 12/066,286

(22) PCT Filed: Sep. 5, 2006
(86) PCT No.: PCT/EP2006/008628

§ 371 Date: Mar. 10, 2008

(30) Foreign Application Priority Data
Sep. 10, 2005 (DE) 10 2005 043 124.0

(51) Int. Cl. F16H 55/17; F16H 1/14

(52) U.S. Cl. 74/420

(57) ABSTRACT

A conical gear (1) with connecting toothing comprises a conical toothing (2) and at least one further toothing (3) which adjoins one end of said conical toothing (2) without a gap, said further toothing (3) having the same number of teeth. In this context, the two toothings are embodied in the manner of involute roller toothings and the junction region between the two toothings extends free of edges, the toothing parameters of the conical toothing (2) and connecting toothing (3) being predefined separately and differently from one another.

The present invention concerns a conical gear with connecting toothing, comprising a conical toothing and at least one further toothing having the same number of teeth and adjoining one end of said toothing without a gap.

Such a conical gear with a connecting toothing fashioned as a spur gear toothing is known from FR 909413. There, the adjoining toothings are separated by an edge.

An edge-free transition between two toothings thus far is known only from the article “Involute toothings with extreme characteristics” by Karheinz Roth and Shyi-Jeng Tsai in the journal Antriebstechnik, 1997, Vol. 36, No. 3, p. 82-90, where for the purpose of relative swiveling capability of two toroidal wheels two conical and spur gear toothings of corresponding toothing parameters pass into each other.

Furthermore, conical gears are already known from the prior art, with a very short spur gear toothing as compared to the axial length of the conical toothing and adjoining the conical toothing axially without a gap, wherein the toothing profile of the spur gear toothing corresponds to the conical toothing profile as projected in the axial direction. Such a spur gear toothing can only be used as a spline toothing.

Moreover, conical gears are known from the prior art with a spur gear toothing as outer toothing adjoining the conical toothing with an axial spacing. The outer toothing in this case is configured as a pure spline toothing and has a smaller tip diameter as compared to the outer diameter of the conical toothing, as well as a different number of teeth than the conical toothing.

Against this background, the problem of the present invention is to provide a conical gear with expanded functionality.

This problem is solved by a conical gear according to the invention with the features of claim 1. Both toothings here, i.e., the conical toothing and the connecting toothing which adjoins it without a gap, have the same number of teeth, so that the toothings can pass directly into each other. The teeth and the tooth edges of the two toothings preferably pass into each other as a single piece. Moreover, both the conical toothing and the connecting toothing are configured in the manner of involute rolling toothings, so that—in contrast with the prior art—the connecting toothing is suitable not only as a spline toothing, but also for a rolling transmission of force to another gear. Finally, the transition region of the toothings that adjoin each other without a gap is configured to be edge-free, and the toothing parameters of conical toothing and connecting toothing are specified separately and different from each other.

A conical gear according to the invention is preferably fabricated by means of a forming production process. The forming techniques which are known to the prior art are available to the practitioner, such as hot and cold forming, and also forging. While in theory a fabrication by machining is also possible, the characteristics of a conical gear according to the invention, especially the lack of edges in the transitional region, can be realized in especially simple manner by a forming production process. Moreover, both the conical toothing and the connecting toothing can be produced at the same time in a single work step.

According to a first advantageous configuration of the invention, the toothing parameters of both toothings in the transitional region satisfy the mutual involute rolling conditions, so that even in the transitional region a gear meshing with one of the two toothings will roll off them in gentle manner.

The connecting toothing is preferably an outer toothing configured as a spur gear toothing, which adjoins the conical toothing axially at its end with a larger modulus, i.e., at the end of greater diameter. But it is also possible to have a spur gear toothing applied at the opposite smaller modulus in such a way that these can be used alternatively with the conical toothing by corresponding gear partners into the transitional region.

In the conical gear of the invention, the design of the conical toothing advantageously corresponds to the rules of DIN 3971 and the outer toothing is configured as a spur gear toothing, preferably according to the rules of DIN 3960.

The conical toothing and/or the connecting toothing of a conical gear according to the invention can advantageously have a convexity. The transitional region is the one in which the two toothings pass into each other free of edges. In the event that both toothings have a convexity, the transitional region can be defined more precisely as the region of the intermeshing toothings that lies between the respective contact areas of the toothings.

The geometry of the two toothings can be dictated separately by appropriate choice of the toothing parameters critical to the respective toothing. For the design of the conical toothing, the ones particularly important for this are the angle of engagement (α_{KV}), its modulus (m_{KV}), its tooth profile modification factor (x_{KV}) and its pitch cone angle (δ_{KV}). For a spur gear toothing, these are in particular its angle of engagement (α_{St}), its modulus (m_{St}), its tooth profile modification factor (x_{St}) and its pitch diameter (d_{St}). The above parameters can vary across the width of the particular toothing, especially in the transitional region.

In another advantageous embodiment of the invention, the toothing parameters of conical toothing and spur gear toothing are chosen in dependence on each other so that both a conical gear rolling against the conical toothing with its toothing reaching into the spur gear toothing of the conical gear and a spur gear rolling against the conical toothing with its spur gear toothing reaching into the conical toothing can roll without hindrance.

Moreover, the conical gear advantageously has a recessed end for its tooth flanks in the transitional region of the toothings, such that the trend of a flank line in the transitional region at both sides passes tangentially into the trend of a flank line of conical or spur gear toothing. This ensures an especially gentle and uniform transition of the two toothings in the region of the tooth flanks.

Again, preferably, the conical gear has a recessed end for the tip diameter of its teeth in the transitional region of the toothings, so that the trend of the tip diameter in the transitional region at both sides passes tangentially into the trend of the tip diameter of conical or spur gear toothing.

Thus, neither the conical toothing nor the spur gear toothing at the outer circumference of the conical gear project beyond the other respective part of the conical gear. Moreover, this assures a smooth, edgeless and round transition, possibly with variable radius, between the two toothings on the outer surface of the invented conical gear.

According to another advantageous embodiment of the invention, the respective modulus of the spur gear toothing or conical toothing has the same value at the intersection of the pitch circle of the spur gear toothing with the pitch cone of the conical toothing, which enables a smooth transition for the toothings. This is especially advantageous when the differing toothing parameters for the conical and the spur gear toothing pass into each other as constantly as possible in a transitional region of the toothings.

Furthermore, the conical gear can also advantageously have an inner spline toothing arranged radially inside the spur gear toothing. This further enhances the functionality of the invented conical gear. On the part of the connecting toothing, advantageously configured as a spur gear toothing, this yields three different possibilities for the force transmission: first, the force transmission can occur via the spur gear toothing, either by rolling against it or by using the spur gear toothing as an outer spline toothing. In the latter case, the spur gear toothing can interact, e.g., with an appropriately adapted inner spline toothing of a hub. Secondly—either optionally or additionally—the inner spline toothing can also be used for the force transmission.

When designing the toothings of a conical gear according to the invention, the spur gear toothing can advantageously result in its parameter-dependent design as a function of the toothing parameters of the conical toothing—taking into account the desired boundary conditions. Thus, with a suitable function f:

(α_{St}, x_{St}, m_{St})=f(α_{KV}, x_{KV}, m_{KV}, δ_{KV}),

where the notation St stands for “spur gear toothing” and KV for “conical toothing”.

The following table illustrates possible boundary regions for the above parameters, as well as the regions to be preferably selected from them:

| Parameter | Boundary region | Preferred region |
|---|---|---|
| α_{St} | 12° to 45° | 17° to 30° |
| X_{St} | −1.0 to 1.0 | −0.5 to 0.5 |
| m_{St} | 0.01 to ∞ | 1 to 20 |
| α_{KV} | 12° to 45° | 17° to 30° |
| X_{KV} | −1.0 to 1.0 | −0.5 to 0.5 |
| m_{KV} | 0.01 to ∞ | 1 to 20 |
| δ_{KV} | 1° to 179° | 10° to 90° |

The preferred regions are obtained by allowing for the expected area of application and the consequent requirements on the invented conical gear. In particular, the potentially available construction space is significant for the preferred region of the modulus of the conical toothing. The preferred region of the angle of attack of the conical toothing is related to the expected load on the tooth flank, the tooth profile modification to the achieved load capacity of the tooth root, and the pitch cone angle to the gear ratio for the conical gear meshing with the conical toothing. Comparable perspectives hold for the spur gear toothing.

As already mentioned above, in a transitional region of the toothings, one should advantageously ensure that the toothings, and especially the tooth flanks, pass into one another as smoothly as possible, thanks to a variable adaptation of the parameters in this region. In the transitional region, one can advantageously place on the function f the boundary condition that the modulus of the spur gear toothing at the intersection of the pitch circle of the cylindrical toothing with the pitch cone of the conical toothing has the same value as the modulus of the conical toothing. Other boundary conditions on the function f will result from the already mentioned advantageous configurations.

Moreover, the present invention is not confined to a straight-toothed conical gearing with an adjoining straight-toothed spur gearing. The above remarks are equally applicable to a slanted-tooth conical gearing with an adjoining slanted-tooth spur gearing, but in this case the slanting angles of spur gearing and conical gearing should preferably correspond to each other.

A sample embodiment of a conical gear according to the invention will now be explained more closely by means of the drawing. This shows:

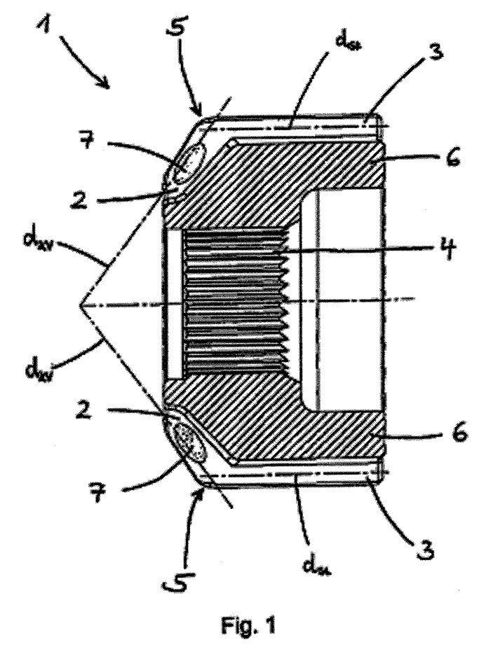

FIG. 1 a longitudinal section through a sample embodiment of a conical gear according to the invention,

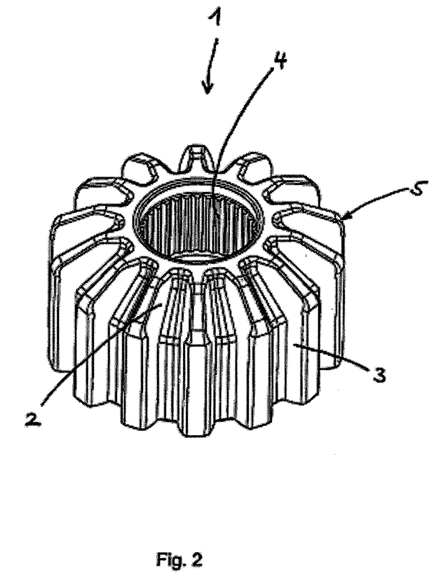

FIG. 2 a perspective representation of the conical gear per FIG. 1, and

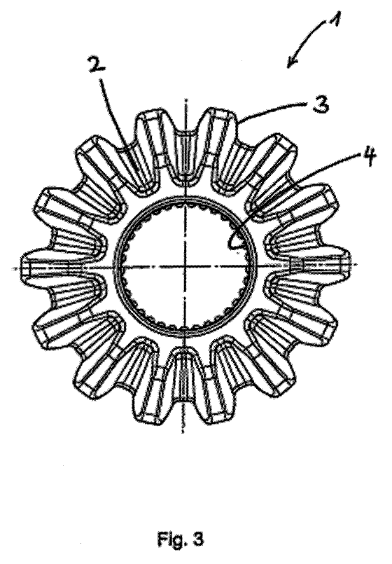

FIG. 3 a frontal plan view of the conical gear per FIGS. 1 and 2.

The sample embodiment of a conical gear 1 according to the invention, depicted in FIG. 1 to 3, comprises a conical toothing 2 and a spur gear toothing 3, adjoining without axial play the former gearing's end with larger modulus, as a connecting toothing. Both toothings 2, 3 have straight teeth. Moreover, the conical gear 1 additionally has an inner spline 4, which is arranged radially inside the spur gear toothing 3 and the conical toothing 2. This can serve, for example, to produce a torsion-proof connection to an outer spline of a shaft or the like. The conical toothing 2 and the spur gear toothing 3 both have the same number of teeth, namely, fourteen. Moreover, the conical toothing 2 and the spur gear toothing 3 are configured as involute rolling toothing, so that each of them is suitable for the transmission of force with a second conical or spur gear meshing with it. Furthermore, it will be noticed that the conical toothing and the spur gear toothing pass directly into each other. The transitional region 5 of the toothings 2, 3 is free of edges. In particular, one will see in the frontal view of FIG. 3 that a spur gear meshing with the spur toothing 3 will not even be disturbed by the conical toothing 2 when it reaches axially into the conical toothing 2. By the same token, even another conical gear rolling against the conical toothing 2 would not be disturbed by the spur toothing 3 if it reached into or even extended beyond the spur toothing 3. At the intersection of the pitch circle d_{St} of the spur toothing 3 with the pitch cone d_{KV} of the conical toothing 2, the modulus of the spur toothing 3 and the modulus of the conical toothing 2 correspond to each other. The teeth in the transitional region 5 have a receding end for their tip diameter, such that the trend of the tip diameter in the transitional region at either end passes tangentially into the trend of the tip diameter of conical toothing 2 and spur toothing 3 in constant fashion and without edges or abrupt change. Moreover, the flanks of the teeth of the conical toothing 2 and the spur toothing 3, passing into each other, are so smoothed out by a fluid transition of the respective toothing parameters in this region that their tooth flanks are free of edges in the transitional region 5. In particular, thanks to a recession of the tooth flanks in the transitional region 5, the flank lines of the toothings in the transitional region 5 at either end pass tangentially into a flank line of the conical toothing 2 and the spur toothing 3. The conical toothing 2 has a convexity, which is illustrated by the contact area 7 shown as a patterned surface in FIG. 1. The axial width of the teeth of the spur toothing 3 is greater than the axial width of the teeth of the conical toothing 2. The conical gear 1 has a radially running extension 6 at its end face on the side with the spur toothing 3, by which one can produce a form fitting with the shoulder of a shaft, joined to the inner spline toothing 4, for example.

1. Conical gear with connecting toothing, comprising a conical toothing and at least one further toothing having the same number of teeth and adjoining one end of said toothing without a gap, characterized in that both toothings are configured in the manner of involute rolling toothings and the transition region between the two toothings is edge-free, and the toothing parameters of conical toothing and connecting toothing are specified separately and different from each other.

2. Conical gear according to claim 1,
characterized in that
the toothing parameters of both toothings in the transitional region satisfy the mutual involute rolling conditions.

3. Conical gear according to claim 1,
characterized in that
the connecting toothing is configured as a spur gear toothing, which adjoins the conical toothing at its end with a larger modulus.

4. Conical gear according to claim 3,
characterized in that
the toothing parameters of conical toothing and spur gear toothing are chosen in dependence on each other so that both a conical gear rolling against the conical toothing with its toothing reaching into the spur gear toothing of the conical gear and a spur gear rolling against the conical toothing with its spur gear toothing reaching into the conical toothing can roll without hindrance.

5. Conical gear according to claim 4,
characterized in that
the conical gear has a recessed end for its tooth flanks in the transitional region of the toothings, such that the trend of a flank line in the transitional region at both sides passes tangentially into the trend of a flank line of conical or spur gear toothing.

6. Conical gear according to claim 4,
characterized in that
the conical gear has a recessed end for the tip diameter of its teeth in the transitional region of the toothings, so that the trend of the tip diameter in the transitional region at both sides passes tangentially into the trend of the tip diameter of conical or spur gear toothing.

7. Conical gear according to claim 4,
characterized in that
the modulus of the spur gear toothing has the same value as the modulus of the conical toothing at the intersection of the pitch circle of the spur gear toothing with the pitch cone of the conical toothing.

8. Conical gear according to claim 3,
characterized in that
the angle of attack of the spur gear toothing lies in a region between 17° and 30°.

9. Conical gear according to claim 3,
characterized in that
the modulus of the spur gear toothing has a value between 1 and 20.

10. Conical gear according to claim 3,
characterized in that
the tooth profile modification factor of the spur gear toothing is chosen with a value between −0.5 and +0.5.

11. Conical gear according to claim 3,
characterized in that
the angle of attack of the conical toothing lies in a region between 17° and 30°.

12. Conical gear according to claim 3,
characterized in that
the modulus of the spur gear toothing has a value between 1 and 20.

13. Conical gear according to claim 3,
characterized in that
the tooth profile modification factor of the spur gear toothing is chosen with a value between −0.5 and +0.5.

14. Conical gear according to claim 3,
characterized in that
the pitch cone angle of the conical toothing lies in a range of 10° to 90°.

15. Conical gear according to claim 3,
characterized in that
the conical gear moreover has an inner spline toothing arranged radially inside the spur gear toothing.

16. Conical gear according to claim 1,
characterized in that
the conical gear is made by forming.
